(19) United States
(12) Patent Application Publication
(10) Pub. No.: US 2014/0010555 A1
(43) Pub. Date: Jan. 9, 2014

(54) PON Video Overlay Amplifier Circuit

(71) Applicants: Travis Lentz, Raleigh, NC (US); James J. Stiscia, Garner, NC (US)

(72) Inventors: Travis Lentz, Raleigh, NC (US); James J. Stiscia, Garner, NC (US)

(73) Assignee: Alcatel-Lucent USA Inc., Murray Hill, NJ (US)

(21) Appl. No.: 13/542,834

(22) Filed: Jul. 6, 2012

(51) Int. Cl. H04B 10/00

(52) U.S. Cl. 398/175

(57) ABSTRACT

An amplifier circuit in a PON and a method for using the same. The amplifier circuit may be used, for example in an ONU of the PON. In order to deal with varying customer requirements and the possibility of the ONUs or similar devices being installed at varying distances from the CO, a dynamically adjustable amplifier bias voltage is determined and applied to at least one amplifier in the amplifier circuit. The dynamic bias voltage is preferably a function of the input power to the ONU or the circuit output quality, or both. More than one dynamic bias voltage may be determined and applied in this fashion.

### TECHNICAL FIELD

The present invention relates generally to the field of communication networks, and, more particularly, to a method and apparatus for processing a received optical signal in a node of a PON or similar access network.

### BACKGROUND

The following abbreviations are herewith defined, at least some of which are referred to within the following description of the state-of-the-art and the present invention.

### A/D Analog-to-Digital

CNR Carrier-to-Noise ratio
CSO Composite second order

### CTB Composite Triple Beat

### D/A Digital-to-Analog

### DSP Digital Signal Processor

### FFT Fast Fourier Transform

### FTTH Fiber to the Home

### GPON Gigabit PON

### MER Modulation Error Ratio

### OLT Optical Line Terminal

### ONT Optical Network Terminal

### ONU Optical Network Unit

### PON Passive Optical Network

### RF Radio Frequency

SNR Signal-to-Noise ratio

### WDM Wave Division Multiplexing

A PON (passive optical network) can be used as an access network for providing various communication services to subscribers. These services may include, for example, Internet access, email, voice telephone, streaming audio and video, and television programming. Television programming may include broadcast and “cable” stations as well as access to movies for free viewing or purchase. Because a single cable—in the case of a PON, a fiber optic cable—must carry information representing all of the things to and from the subscriber, techniques have been developed for allowing all of this information traffic to traverse the fiber at the same time without interference.

The technique of video overlay involves sending video signals downstream through a PON using a different wavelength of light than is used for other information. The two (or more) wavelengths of light are then multiplexed for simultaneous transmission as needed to provide all of the information to the subscriber without undue delay. When the light carrying these signals reaches the subscriber the video overlay wavelength is separated again for separate processing. The device where this occurs is often called an ONU (optical network unit) and is located at the residence or business premises of the subscriber.

When the video overlay signal arrives at the ONU (or similar device) it is amplified to make it more useful to the subscriber equipment that will use or distribute it to other subscriber devices. As might be expected, this amplification is performed in a circuit that includes a number of electrical components after the optical video overlay signal is converted into an electrical signal. One or more of these components is in fact an amplifier. As the signal is being amplified, the output if the amplifier or amplifiers is influenced by the application of a bias voltage. If this bias voltage is static, that is constant and unchanging, it is set in advance.

The problem with setting a static bias voltage in advance is that the ONUs are often manufactured in large quantities before it is know who they will be sold to and where they will be installed. Different carriers have different requirements for acceptable input and output characteristics of the ONU. The use of a pre-set static bias voltage in the video overlay amplification circuit can mean in some cases that these requirements are not met, and additional work is needed to re-set the voltage. Of course, making a variety of ONUs is possible, but increases costs for the manufacturer.

In addition, it is difficult to in advance to know the environment the ONU will be used in. Some, for example, will be installed relatively-close to the CO (central office) where the optical signal originates while others are much further away. This can result in some ONUs receiving the optical signal at a much higher power level than others. This may be a problem, for example, if the static bias voltage is set to optimize amplifier distortion performance at relatively high optical input power to avoid common distortions such as CSO or CTB. If the ONU happens to be installed far from the CO, however, this setting may be accompanied by high thermal noise at the relatively-low optical input power and would impact receiver sensitivity performance.

Note that the techniques or schemes described herein as existing or possible are presented as background for the present invention, but no admission is made thereby that these techniques and schemes were heretofore commercialized or known to others besides the inventors.

Accordingly, there has been and still is a need to address the aforementioned shortcomings and other shortcomings associated with amplifying video overlay signals. These needs and other needs are addressed by the present invention.

### SUMMARY

The present invention is directed to a method and amplifier circuit for use in, for example, receiving a video overlay signal in a PON (passive optical network). In one embodiment, the present invention is amplifier circuit for receiving a video overlay signal and producing an amplified output for, for example, providing to a subscriber device. According to this aspect, the amplifier circuit includes a primary amplifier chain having at least one amplifier for amplifying the received signal and a bias voltage generator for generating a bias voltage for biasing the at least one amplifier in the primary amplifier chain based on at least one characteristic of the received signal. In this embodiment, the present invention may also include an ONU (for example, an ONT) in which the amplifier circuit is resident.

In most embodiments of this aspect of the present invention, the amplifier circuit also includes a light sensing device such as a photodiode for converting a received optical overlay signal and converting it into an electrical signal. In some embodiments, the primary amplifier chain includes one or more of a TIA (trans-impedance amplifier), an attenuator or attenuator circuit, and a post amplifier. In that case, the at least one amplifier may be the TIA or the post amplifier or both.

In this aspect the bias voltage generator may include a comparator for comparing a voltage signal representative of the overlay signal to a reference voltage. In some implementations the reference voltage is manually or automatically adjustable. A sensing circuit in communication with the light sensing device may be present for creating the voltage signal representative of the overlay signal. The bias voltage generator may further include a gain and level amplifier for amplifying the output of the comparator and a limiter circuit for limiting the output of the gain and level amplifier prior to applying the output as the bias voltage for the at least one amplifier of the primary amplifier chain.

In other embodiments the bias voltage generator comprises a microcontroller, the microcontroller for generating at least one bias voltage for biasing the at least one amplifier of the primary amplifier chain based on stored program instructions and the at least one characteristic of the received signal. In this embodiment, the bias voltage generator may also include a coupler for tapping the output of the primary amplifier circuit and providing a representation of the output to a measurement DSP, the measurement DSP for analyzing the output of the primary amplifier chain and providing the analysis as an input to the microcontroller. Signal characteristics to be analyzed by the measurement DSP may include one or more of MER, CNR, CTB, and CSO. In this case the bias voltage may also be based on the DSP analysis of the primary amplifier output analysis. In some embodiments, inputs to the microcontroller or the measurement DSP or both may be converted by an analog-to-digital converter, which may be a part of the microcontroller or one or more separate components. Likewise the voltage bias output of the microcontroller may be converted by a respective digital-to-analog converter, which again may be separate or integrally-formed with the microcontroller, prior to being applied to the at least one amplifier in the primary amplifier chain. In most embodiments a non-transitory memory device for storing program instructions is in communication with or integrally formed with the microcontroller. In some embodiments, the at least one bias voltage comprises a second bias voltage for biasing a second amplifier of the primary amplifier chain.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIG. 1 is a simplified schematic diagram illustrating a typical PON;

FIG. 2 is a simplified schematic diagram illustrating a PON implementing video overlay transmission;

FIG. 3 is a simplified schematic diagram illustrating a video overlay amplifier circuit according to an embodiment of the present invention;

FIG. 4 is a simplified schematic diagram illustrating a video overlay amplifier circuit according to another embodiment of the present invention; and

FIG. 5 is a flow diagram illustrating a method of receiving a video overlay signal according to an embodiment of the present invention.

### DETAILED DESCRIPTION

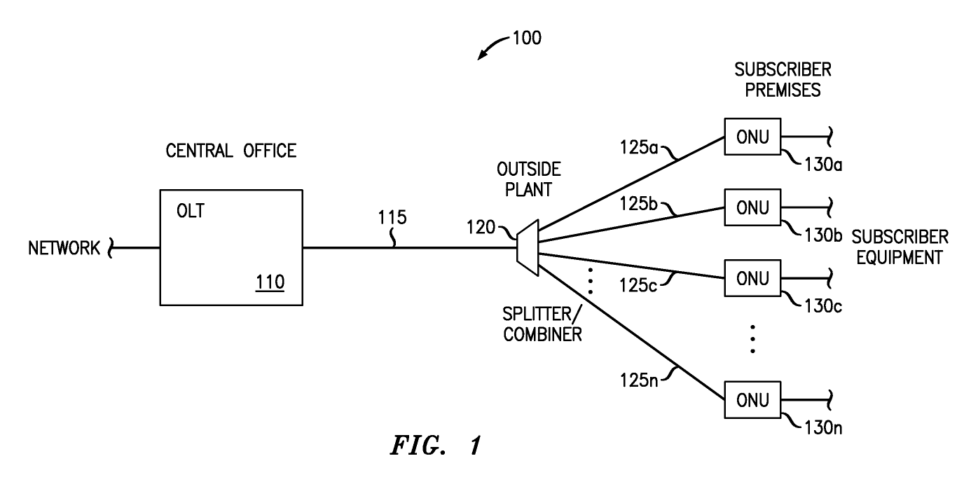

The present invention provides an amplifier circuit for use in, for example, receiving the video overlay portion of a PON signal. FIG. 1 illustrates an exemplary PON in which an embodiment of the present invention may be employed. FIG. 1 is a simplified schematic diagram illustrating a typical PON 100. PON 100 is what is frequently referred to as an access network, which connects a large number of subscriber networks to a central or core network.

This exemplary PON 100 includes an OLT (optical line terminal) 110, which among other functions serves as a connection between a core network or networks (not shown). “Core network” is here being used in the general sense as a communication network through which subscribers may obtain downloaded content, communicate with others, access the Internet, and similar functions. The core network may itself include, for example, application servers and data storage devices for facilitating these functions or may interconnect with other networks, or both.

Downstream traffic from the core network is directed to one or more subscribers via the PON 100, and upstream traffic flows in the other direction, from subscribers toward the core network. Generally speaking, in this exemplary PON 100, the OLT 110 includes the apparatus (not shown in FIG. 1) necessary for exchanging network and subscriber communications. In many installations OLT 110 is physically located in a building or similar structure referred to as the CO (central office).

For effecting downstream transmissions, the OLT includes at least one light source (not shown), which may for example be a laser or LED device. Light generated by the light source propagates along feeder fiber 115 until it is received in optical splitter/combiner 120 (sometimes referred to for convenience as simply an optical splitter).

In exemplary PON 100, optical splitter 120 distributes the light propagated downstream along feeder fiber 115 to a number of outputs. In FIG. 1, four such outputs are shown, each communicating with a respective access fiber. The access fibers are in FIG. 1 referred to as 125a through 125n. As indicated by the ellipsis, there may be additional access fibers communicating with their own respective optical splitter outputs (there may of course, be less than four as well). Although not shown in FIG. 1, each output may form a port into which an access fiber connector is received.

Optical splitter 120 is typically a passive device requiring no power but simply distributing light propagating in the downstream direction onto each one of its ports. In many PONs, therefore, the signals transmitted in the propagated light are identically passed to each of the access fibers. In the PON 100 of FIG. 1, these signals are received at ONUs (optical network units) 130a through 130n, each of which communicate with a respective one of access fibers 125a through 125n.

An ONU may be associated with a single subscriber, as is, for example, an ONT (optical network terminal; not shown), and is often located on or near the subscriber's premises. In the example of FIG. 1, this is assumed to be the case for ONUs 130a through 130n. Each of the ONUs 130a through 130n includes at least one light detector (not shown), and acts as the interface between the PON 100 and one or more subscriber devices such as a home router or gateway (also not shown).

Note that in this exemplary PON 100, each of the ONUs receives the same downstream transmission but selects only that portion of the transmission stream addressed to it. Data not addressed to a particular ONU is simply discarded. Upstream traffic in exemplary PON propagates along the same path, originating in the ONUs 130a through 130n and transmitted in accordance with a time schedule established by OLT 110. The upstream traffic may use light of a different wavelength to avoid interference with downstream traffic, but the schedule is usually necessary so that ONU transmissions don't interfere with each other. A transmission from one of the ONUs 130a through 130n propagates along a respective one of the access fibers 125a through 125n to optical splitter combiner 120, where it is placed on feeder fiber 115 and eventually reaches a light detector (not shown) in OLT 110.

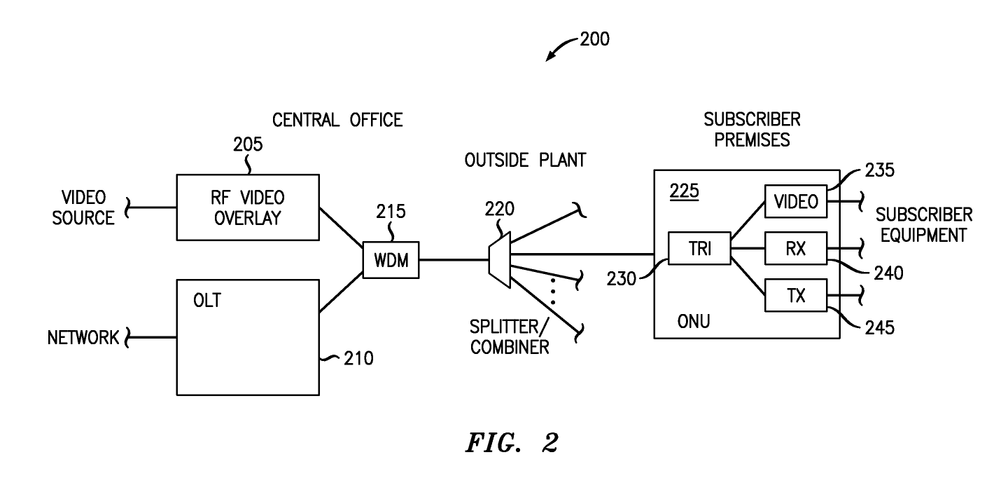

In many implementations, it is desirable to transmit video transmissions such as motion pictures or television programming to subscribers over the PON. One technique that has been developed for this purpose is often referred to as RF video overlay. FIG. 2 is a simplified schematic diagram illustrating a PON 200 implementing video overlay transmission. As can be seen in FIG. 2, PON 200 includes an OLT 210 that provides an interface between a core network and the remainder of the access network, similar if not identical to the OLT 110 of PON 100 (shown in FIG. 1).

In the embodiment of FIG. 2, PON 200 also includes a RF video overlay optical unit 205, which receives video programming from a video source (or sources) and converts it into an optical signal for downstream transmission over the fibers of PON 200. In many implementations, the RF video overlay (typically analog) signal is generated at a wavelength of 1550 nm, as compared with a typical 1490 nm for downstream traffic from the OLT 210. In the embodiment of FIG. 2, the signals from the video overlay optical unit 205 and OLT 210 are fed to WDM (wavelength division multiplexer) 215 and the resultant multiplexed optical signal is propagated downstream.

In the embodiment of FIG. 2, the optical signal from the WDM 215 is received at the splitter 220, where it is distributed to a number of outputs, each associated (or associable) with an ONU located at a subscriber premises. One such ONU 225 is depicted in FIG. 2. ONU 225 in this embodiment includes a triplexer 230 for receiving the optical signal propagating downstream from the WDM 215 via the splitter 220. The triplexer 230 outputs the video overlay signal and provides it to the video circuitry 235, which will be described in more detail below. Also output from triplexer 230 is the optical signal from the ONT 210, which is provided to the receive circuitry 240 for processing. Triplexer 230 also receives upstream optical transmissions from the transmit circuitry and for propagation toward OLT 210 via splitter 220.

As should be apparent from the description above, the video overlay signal is in the usual case separately processed in the ONU 225. The arrangement for processing the video overlay signal will now be discussed in more detail.

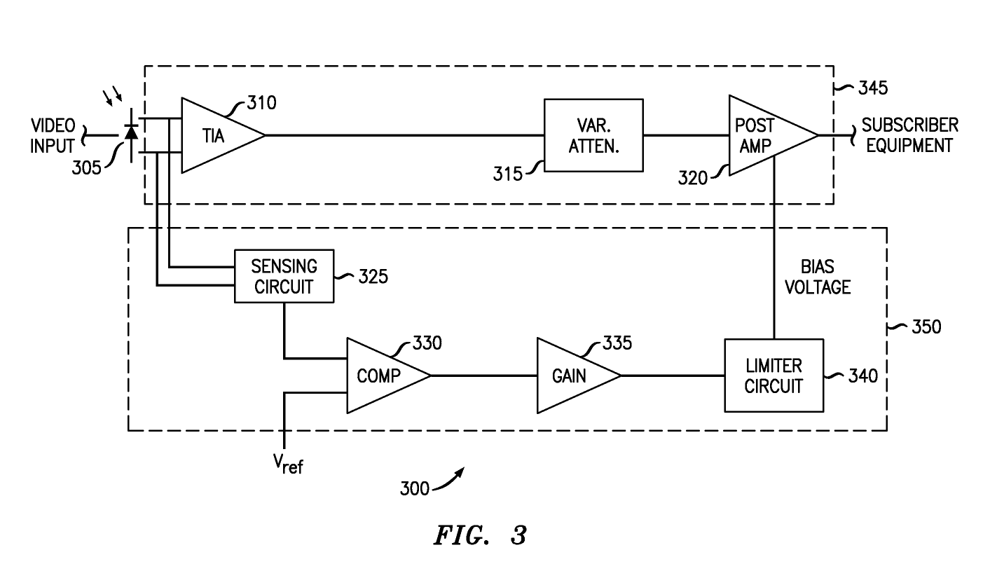

FIG. 3 is a simplified schematic diagram illustrating a video overlay amplifier circuit 300 according to an embodiment of the present invention. In this embodiment, it is presumed that a video overlay input, for example an optical 1550 nm RF video overlay as may be found in use today. The video input may be received via, for example, an ONU triplexer (see FIG. 2). In most embodiments the video signal is transmitted from a central office at the upstream end of a PON while the video overlay amplifier circuit is resident in an ONU at the downstream end of the PON. The video overlay amplifier circuit in this embodiment processes the received video overlay signal in preparation for passing it on to the subscriber equipment. Note that in other embodiments, there may also be addition pre- or post-circuit components or processing.

In the embodiment of FIG. 3, the video overlay amplifier circuit 300 includes a photodiode 305 or similar light sensing device. The photodiode 305 converts the received light signal into an electrical signal which is then provided to primary amplifier chain 345. In this embodiment, primary amplifier chain 345 includes a TIA (trans-impedance amplifier) 310. The TIA 310 receives the current output of the photodiode and converts it into a voltage. Advantageously, the TIA 310 may often be set to maximum gain, in an effort to optimize performance, because of the dynamic bias voltage applied by this embodiment of the present invention. This voltage signal is applied to a variable attenuator 315, which attenuates the signal before applying it to a post amplifier 320, which produces a signal to transmit to the subscriber network, often but not necessarily via a router or similar device.

As mentioned above, a bias voltage may be advantageously applied to the primary amplifier chain 345, often to the primary chain post amplifier 320 as shown in FIG. 3. As also mentioned, however, the problem with assigning a static bias voltage is that the selected voltage may not be suitable in all environments, producing in some deployments unsatisfactory picture quality or the need for a technician to make cumbersome field adjustments.

For example, each ONU in a PON may be installed at a different distance from the central office compared with the other ONUs, and the difference in distance may for some units be quite large. In addition, carriers may specify broad input dynamic range requirements. This means that one setting of the amplifier bias voltage may result in uneven performance from one ONU to the next.

An improved video overlay amplifier circuit may be configured by introducing a dynamic bias voltage for the primary amplifier chain 345. In the embodiment of FIG. 3, the dynamic bias voltage for is provided by bias voltage chain 350. In this embodiment, dynamic bias voltage chain 350 includes a sensing circuit 325, which creates a representation of the current produced by the photodiode 305 as a voltage signal. In another embodiment, the voltage signal could instead be created read from the TIA output, although this is not a preferred configuration.

In the embodiment of FIG. 3, the voltage signal from sensing circuit 325 is then provided to a comparator 330 of bias voltage chain 350. A reference voltage V_{ref} is also applied to the comparator 330, and the resulting signal is providing to a gain and level shift amplifier 335. The gain and level shift amplifier 335 produces an amplified signal that is then provided to a limiter circuit 340, which prevents excessive swings in the bias voltage that is then provided to the post amplifier 320 of primary amplifier chain 345.

In this manner a dynamic bias voltage is provided by bias voltage chain 350 to primary amplifier chain 345 of video overlay amplifier circuit 300. The dynamic bias voltage adjusts automatically as a function of (at least) the optical input received by the photodiode, within the parameters imposed by the design characteristics of the components of bias voltage chain 350, in this embodiment comparator 330, gain and level amplifier 335, and limiter circuit 340. Note that these parameters may vary from implementation to implementation.

Note that in the embodiment of FIG. 3, V_{ref} is assumed to be fixed. In some implementations, however, an adjustable reference voltage may be preferred. For example, an exemplary deployment may involve a video overlay signal including 135 digital 256-QAM channels in the 50 to 870 MHz range. When an all-digital channel signal is used, it may be preferred to minimize thermal generation and improve the video amplifier EIN (equivalent input noise). If, on the other hand, the video overlay signal carries analog or both analog and digital channels, if may be preferable to optimize third order distortion. Adjusting V_{ref} permits these distinctive environments to be accommodated. An ONU with an adjustable V_{ref} is more easily adaptable to either situation. V_{ref} may be adjustable, for example, by a microcontroller that senses the channel composition or strength of the input signal, or both. Note that when a microcontroller is recited herein, it is implied that the same function may be performed by a microprocessor or controller or similar device.

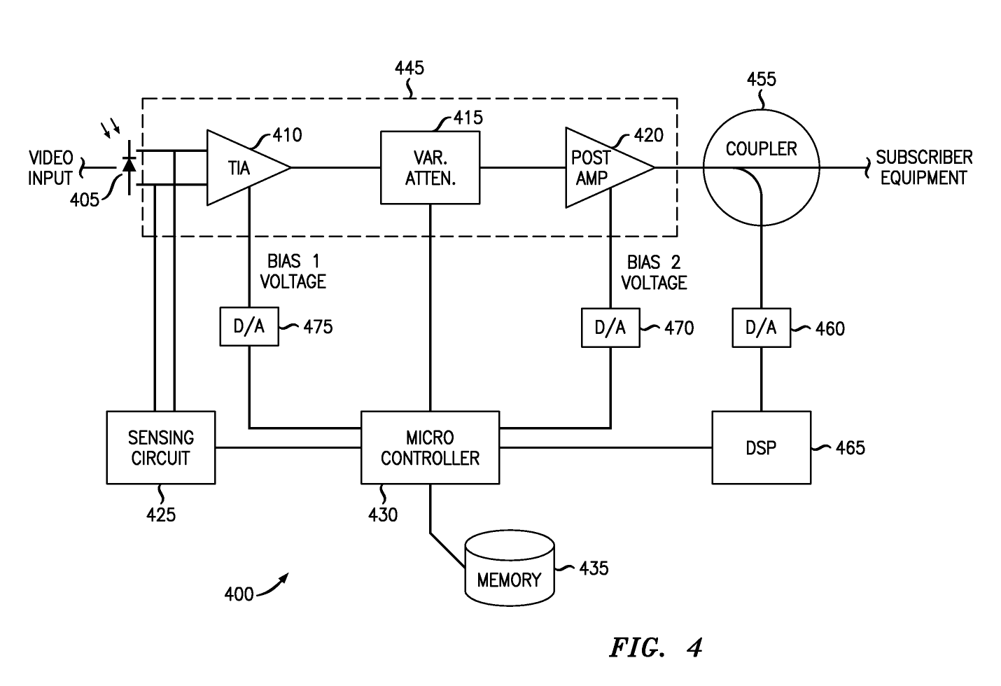

Other embodiments are possible, for example FIG. 4 is a simplified schematic diagram illustrating a video overlay amplifier circuit 400 according to another embodiment of the present invention. It is noted that this embodiment in some respects similar though not necessarily identical to the circuit 300 of FIG. 3. The video amplifier circuit 400 of FIG. 4 includes a photodiode 405 or similar light sensing device. The photodiode 405 converts the received light signal into an electrical signal which is then provided to primary amplifier chain 445. In this embodiment, primary amplifier chain 445 includes a TIA (trans-impedance amplifier) 410. The TIA 410 receives the current output of the photodiode and converts it into a voltage. This signal is applied to a variable attenuator 415, which attenuates the signal before applying it to a post amplifier 420, which produces an amplified signal to transmit to the subscriber network, often but not necessarily via a router or similar device.

In the embodiment of FIG. 4, the dynamic voltage biasing of the primary amplifier chain 445 is applied according to the direction of microcontroller 430 executing program instructions stored in memory device 435. Memory device 435 is a physical, non-transitory device for storing program instructions and data for use by microcontroller 430 and in some cases other components of video overlay amplifier circuit 400.

In this embodiment, sensing circuit 425 creates a representation of the current produced by the photodiode 305 as a voltage signal, which can then be provided to microcontroller 430. Microcontroller 430 therefore is always aware of the strength of the input signal being received at photodiode 405. In this embodiment, it is also aware of the output at post amplifier 420. Coupler 435 provides the output to the subscriber equipment, but also permits an indication of the output to be provided to DSP (digital signal processor) 465 via an analog-to-digital (A/D) converter 460.

In this embodiment, DSP 465 performs selected measurements to determine the fidelity of the post amplifier output signal to desired parameters. The relevant parameters may include one or more of CNR (carrier-to-noise ratio), SNR (signal-to-noise ratio), MER (modulation error ratio), CSO (composite second order) performance, CTB (composite triple beat) performance, or other parameters as established by the network operator. The DSP 465 function may include, for example, FFT (fast fourier transform) spectral decomposition and filtering necessary to test specific parameters. Other functions may of course be employed.

In the embodiment of FIG. 4, the measurement DSP then outputs the measurement results to the microcontroller 430. As shown, the microcontroller may also provide input to variable attenuator 415 to direct the attenuation of the signal from TIA 410.

Microcontroller 430 then determines the bias voltage that should be applied to the primary amplifier chain 445 and generates the necessary output. In this embodiment, a first bias voltage is applied to the TIA 410 via digital-to-analog (D/A) converter 475, and a second bias voltage is applied to post amplifier 420 via digital-analog converter 470

In the embodiment of FIG. 4, the dynamic bias voltage or voltages adjust automatically as a function of the optical input received by the photodiode 405 and the output of post amplifier 420, within the parameters imposed by the design characteristics of the microcontroller 430 and its executable programs in conjunction with the measurement capabilities of the DSP 465. Note that these parameters may vary from implementation to implementation, and may be set by the manufacturer or network operator according to their preference for optimizing certain performance characteristics.

Note also that in other embodiments (not shown) only one of the bias voltages may be applied by the microcontroller 430. In yet other embodiments, either the first or second bias voltage may be static or a dynamic bias voltage may be applied by a bias voltage chain as shown in FIG. 3.

Finally, note that while for illustration memory device 435, DSP 465, analog-to-digital converter 460, and digital-to-analog (D/A) converters 470 and 475 are shown as separate components from microcontroller 430, in other embodiments (not shown) any or all of these components may be integrally-formed with the microcontroller. And in accordance with the present invention, microcontroller 430 and DSP 465 may be implemented, separately or in a single unit, as a physical processor executing instructions stored as software in a non-transitory medium, or as a combination of executable software and hardware, or as hardware devices.

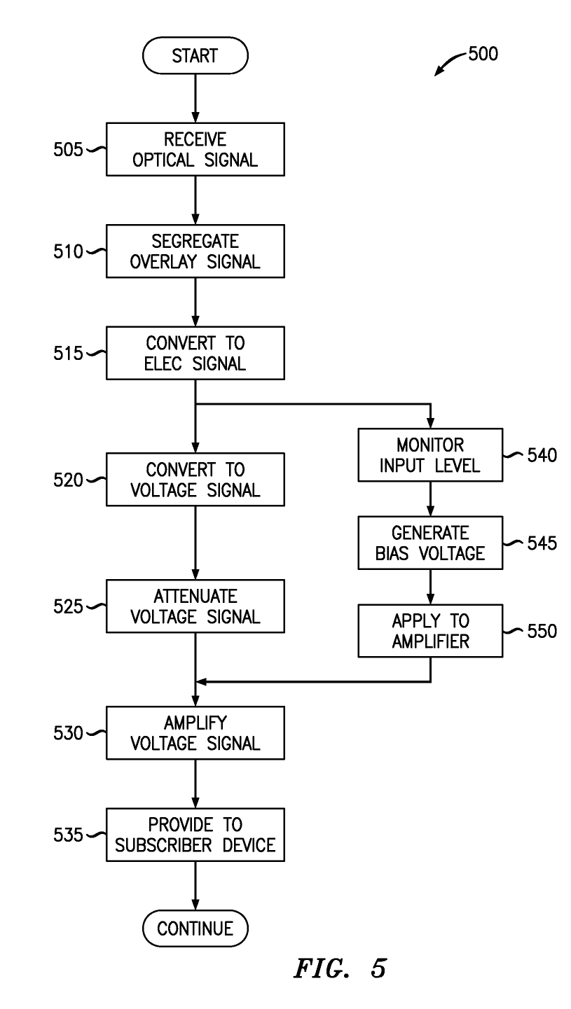

FIG. 5 is a flow diagram illustrating a method 500 of receiving a video overlay signal, for example at an ONU of a PON, according to an embodiment of the present invention. At Start it is presumed that the components necessary for performing the method are available and operational according to this embodiment. The process then begins when an optical signal is received (step 505). When the optical signal is received, the video overlay portion of the signal is segregated (step 510), for example by a triplexer or similar device, for separate processing.

In this embodiment, the optical signal is then converted (step 515) into an electrical signal, for example by a photodiode. The resulting current signal is then converted (step 520) into a voltage signal, for example by a TIA, and typically at this stage amplified as well (not separately shown). The resulting electrical signal is attenuated (step 525) and provided to a post amplifier where it is amplified (step 530) before being provided a subscriber device (step 535). Note that as used herein, “subscriber device” includes such a device whether or not it is actually installed at a subscriber premises, and also any testing or sampling devices used to simulate the subscriber device or accept the signal of the post amplifier, for example during manufacture and testing.

In the embodiment of FIG. 5, the input power level is also monitored (step 540), for example by a sensing circuit (see FIGS. 3 and 4). A bias voltage that is a function of at least the input power level is generated (step 545). This may be done for example using a comparator (see FIG. 3) or a microcontroller alone (see FIG. 4) or a microcontroller in combination with a DSP (see FIG. 4). The bias voltage is then applied to the post amplifier (step 550). In some embodiments, the bias voltage is produced by comparing a voltage representation of the input signal to a reference voltage. In this case the bias voltage may be amplified and conditioned by a limiter circuit see FIG. 3) prior to being applied to the post amplifier at step 550.

In another embodiment, the bias voltage may be produced by a microcontroller that is provided with a representation of the input signal as in input. In this case, the microcontroller may also received measurements related to the output of the post amplifier as an input as well. In some embodiments, a bias voltage may be applied to the TIA as well as or instead of the post amplifier. If applied to both of course the bias voltages do not have to be identical. In any case, the process preferably continues as long as an input signal is being received.

Note that the sequence of operation illustrated in FIG. 5 represents an exemplary embodiment; some variation is possible within the spirit of the invention. For example, additional operations may be added to those shown in FIG. 5, and in some implementations one or more of the illustrated operations may be omitted. In addition, the operations of the method may be performed in any logically-consistent order unless a definite sequence is recited in a particular embodiment.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An amplifier circuit for receiving a video overlay signal and producing an amplified output, comprising:
a primary amplifier chain comprising at least one amplifier for amplifying the received signal; and
a bias voltage generator for generating a bias voltage for biasing the at least one amplifier in the primary amplifier chain, wherein the bias voltage is based on the at least one characteristic of the received signal.

2. The amplifier circuit of claim 1, further comprising an ONU in which the amplifier circuit is resident.

3. The amplifier circuit of claim 1, further comprising a light sensing device for converting a received optical overlay signal and converting it into an electrical signal; and wherein the primary amplifier chain comprises a TIA to receive the electrical signal from the light sensing device and a post amplifier in communication with the TIA for amplifying the overlay signal.

4. The amplifier circuit of claim 3, wherein the post amplifier is the at least one amplifier.

5. The amplifier circuit of claim 3, further comprising a variable attenuator for attenuating the output of the TIA prior to its input to the post amplifier.

6. The amplifier circuit of claim 1, wherein the bias voltage generator comprises a comparator for comparing a voltage signal representative of the overlay signal to a reference voltage.

7. The amplifier circuit of claim 6, wherein the reference voltage is adjustable.

9. The amplifier circuit of claim 6, wherein the bias voltage generator further comprises a gain and level amplifier for amplifying the output of the comparator.

10. The amplifier circuit of claim 9, wherein the bias voltage generator further comprises a limiter circuit for limiting the output of the gain and level amplifier prior to applying the output as the bias voltage for the at least one amplifier of the primary amplifier chain.

11. The amplifier circuit of claim 6, wherein the bias voltage generator comprises a microcontroller, the microcontroller for generating the bias voltage for biasing the at least one amplifier of the primary amplifier chain based on stored program instructions the at least one characteristic of the received signal.

12. The amplifier circuit of claim 11, further comprising a coupler for tapping the output of the primary amplifier circuit and providing a representation of the output to a measurement DSP, the measurement DSP for analyzing the output of the primary amplifier chain and providing the analysis as an input to the microcontroller.

13. The amplifier circuit of claim 11, wherein the at least one amplifier of the primary amplifier chain comprises a second amplifier and wherein the microcontroller generates a second bias voltage for biasing a second amplifier.

14. A method of amplifying a received optical RF overlay video signal, comprising:
converting the optical signal into an electrical signal;
determining at least one characteristic of the received signal;
generating a bias voltage based on the at least one characteristic of the received signal; and
amplifying the electrical signal in a primary amplifier chain comprising at least one amplifier biased by the bias voltage.

15. The method of claim 14, further comprising providing the amplified electrical signal to a subscriber device.

16. The method of claim 14, wherein the at least one characteristic is the power level of the received signal.

17. The method of claim 14, wherein the at least one characteristic is the nature of the received signal.

18. The method of claim 14, wherein determining at least one characteristic of the electrical signal comprises converting the electrical signal into a voltage signal; and wherein generating a bias voltage comprises applying the voltage signal to a comparator as one input and a reference voltage as another.

19. The method of claim 18, wherein generating a bias voltage comprises amplifying the output of the comparator and passing the amplified bias voltage through a limiter circuit before biasing the at least one amplifier.

20. The method of claim 18, wherein the primary amplifier chain comprises a TIA for converting the electrical signal into a voltage signal and a post amplifier, and wherein the at least one amplifier biased by the bias voltage is the post amplifier.

21. The method of claim 20, further comprising attenuating the output of the TIA prior to applying the voltage signal to the post amplifier.

22. An ONU comprising an amplifier circuit for receiving a video overlay signal and producing an amplified output, the amplifier circuit comprising a primary amplifier chain comprising at least one amplifier for amplifying the received signal, and a bias voltage generator for generating a bias voltage for biasing the at least one amplifier in the primary amplifier chain, wherein the bias voltage is based on the at least one characteristic of the received signal.
